(19) United States
(12) Patent Application Publication
(10) Pub. No.: US 2023/0375859 A1
(43) Pub. Date: Nov. 23, 2023

(54) LENS ELEMENT COMPRISING AN ACTIVABLE OPTICAL ELEMENT

(71) Applicant: Essilor International, Charenton-Le-Pont (FR)

(72) Inventors: Claudine BIVER, Charenton-Le-Pont (FR); Samuel ARCHAMBEAU, Charenton-Le-Pont (FR)

(73) Assignee: Essilor International, Charenton-Le-Pont (FR)

(21) Appl. No.: 18/044,088

(22) PCT Filed: Sep. 8, 2021
(86) PCT No.: PCT/EP2021/074705

§ 371 Date: Mar. 6, 2023

(30) Foreign Application Priority Data
Sep. 8, 2020 (EP) 20305991.0

(51) Int. Cl. G02C 7/08

(52) U.S. Cl. CPC G02C 7/083; G02C 2202/24

(57) ABSTRACT

A lens element intended to be worn in front of an eye of a wearer having a first optical function, and comprising at least one activable optical element, wherein in a first state the at least one activable optical element contributes with the rest of the lens to focus the image of an object at distance on the retina of the wearer, and in a second state the at least one activable optical element has a second optical function of scattering light so as to slow down the progression of the abnormal refraction of the eye.

### FIELD OF THE DISCLOSURE

The disclosure relates to a lens element intended to be worn in front of an eye of a wearer having a first optical function, for example based on a prescription of the wearer for correcting an abnormal refraction of said eye of the wearer, and comprising at least one activable optical element.

The disclosure further relates to an optical device adapted to be positioned on a lens element and to an eyewear device comprising lens elements.

### BACKGROUND OF THE DISCLOSURE

Myopia of an eye is characterized by the fact that the eye focuses distant objects in front of its retina, hypermetropia is characterized by the fact that the eye focuses distant objects behind of its retina. Myopia is usually corrected using a concave lens providing negative dioptric power and hypermetropia is usually corrected using a convex lens providing positive dioptric power.

It has been observed that some individuals when corrected using conventional single vision optical lenses, in particular children, focus inaccurately when they observe an object which is situated at a short distance away, that is to say, in near vision conditions. Because of this focusing defect on the part of a myopic child which is corrected for his far vision, the image of an object close by is also formed behind his retina, even in the foveal area.

Such focusing defect may have an impact on the progression of myopia of such individuals. One may observe that for most of said individual the myopia defect tends to increase over time partly caused by long and intensive near work sessions.

In particular, studies carried out on monkeys have shown that strong defocusing of the light behind the retina, which occurs away from the foveal zone, may cause the eye to extend and therefore may cause a myopia defect to increase.

Recent improvements in the field of ophthalmic lenses, have allowed developing optical lenses comprising optical elements to prevent, or at least slow down, the progression of abnormal refractions of an eye such as myopia or hyperopia.

Different solutions exist using either micro lenses or light scattering structures on lenses keeping always a clear zone around the optical axis. Such scattering features can be dots realized on the surfaces of the lens or inclusions inside the bulk of the lens made for example by laser engraving. These structures generate some defocus or haze and reduce visual acuity of the wearer in the periphery of his visual field.

The existing solutions may present drawbacks, in particular in presence of a high luminosity such as a bright light source or sunlight, lenses bearing micro lenses or scattering microstructures on their surfaces or inside the bulk can generate strong dazzling and hence huge discomfort for the wearer.

Therefore, there is a need for a solution to provide a lens element that would overcome such drawback while still providing the function of slowing down the progression of the abnormal refraction of the eye.

A goal of the present disclosure is to provide such a lens element.

### SUMMARY OF THE DISCLOSURE

To this end, the disclosure proposes a lens element intended to be worn in front of an eye of a wearer having a first optical function, for example based on a prescription of the wearer for correcting an abnormal refraction of said eye of the wearer, and comprising at least one activable optical element, wherein in a first state the at least one activable optical element contributes with the rest of the lens to focus the image of an object at distance on the retina of the wearer, and in a second state the at least one activable optical element has a second optical function of scattering light so as to slow down the progression of the abnormal refraction of the eye.

Advantageously, the lens element according to the disclosure allows controlling the level of haze perceived by the wearer and also the duration of exposure to such haze. The active optical lens element allows customizing the overall optical function to adapt the diffusion according to each wearer needs.

According to further embodiments which can be considered alone or in combination:
the lens element further comprises a refraction area formed as the area other than the areas comprising the at least one activable optical element and having a refractive power based on the prescription for said eye of the wearer; and/or
the refraction area comprises the fitting cross of the lens element, for example extends at least 5 mm around the fitting cross; and/or
the at least one activable optical element is located on the front surface, the back surface, or between the front and the back surfaces of the lens element; and/or
the at least one activable optical element further comprises:
   ○a first substrate and a second substrate being arranged to face the first substrate and form a cavity between said first and second substrates,
   ○an active material disposed between the first and second substrates, the active material being activable between at least a first state and a second state,
wherein the first state corresponds to a deactivated light scattering function and the second state corresponds to an active light scattering function; and/or
the active material is an electro-active material and wherein the at least one activable optical element further comprises:
   ○a first conductive layer disposed on the surface of the first substrate facing the electro-active material,
   ○a second conductive layer disposed on the surface of the second substrate facing the electro-active material; and/or
the first and second conductive layer are structured electrodes allowing to activate the electro-active material in specific areas of the lens element; and/or
the active material is a thermo-optical material whose index of refraction varies with temperature; and/or
the transmission of the substrate with the electrode, for example of the lens element, is higher than 25%, preferably higher than 70% and even preferably higher than 80%; and/or
the active material is a photo-active material; and/or
the active material is activable between at least a transparent state and a scattering induced state, for example PDLC, SPD, or liquid crystal in a cholesteric phase, or holographic switchable materials; and/or
the first substrate has a first index of refraction and a light scattering structure providing the second optical function, the second substrate has said first index of refraction, wherein in a first state, the first and second substrates and the active material have the same index of refraction and participate to the first optical function, and in a second state, the index of refraction of the active material is modified, thereby activating the second optical function; and/or
the lens element comprises:
   ○a substrate having a first index of refraction,
   ○at least one holographic mirror disposed on the face of the substrate facing the wearer when the lens element is worn by the wearer,
   ○at least one activable light source,
wherein in a first state, the light source is off, and in a second state, the at least one activable light source generates light that reflected on the holographic mirror generates an image of a scattered element that is reflected toward the eye of the user thereby activating the second optical function of the at least one activable optical element; and/or
the lens element further comprising receiving means configured to receive data, and wherein the transitions between the first and second states of the optical element are driven in real-time based on the received data.

The disclosure relates to a use of the lens element according to the disclosure.

Advantageously, the use of the lens element according to the disclosure enables to slow down the progression of myopia.

The disclosure also relates to an optical device adapted to be positioned on a lens element having a first optical function, for example based on a prescription of a wearer for correcting an abnormal refraction of said eye of the wearer, wherein the optical device comprises at least one activable optical element configured so that in a first state the at least one activable optical element contributes with the lens element to focus the image of an object at distance on the retina of the wearer, and in a second state the at least one activable optical element has a second optical function of scattering light so as to slow down the progression of the abnormal refraction of the eye.

According to an embodiment, wherein the at least one active optical element comprises a microstructure or at least one micro-lens.

The disclosure finally relates to an eyewear device comprising lens elements, each lens element has an optical function, for example based on a prescription of the wearer for correcting an abnormal refraction of said eye of the wearer, and comprises at least one activable optical element, wherein in a first state the at least one activable optical element contributes with the rest of the lens to focus the image of an object at distance on the retina or the wearer, and in a second state the at least one activable optical element has a second optical function of scattering light so as to slow down the progression of the abnormal refraction of the eye.

The eyewear device according to the disclosure may comprise a spectacle frame and the lens elements may be mounted in the spectacle frame.

The eyewear device may further comprise electronic parts to control the at least one activable optical element, eventually a light source, receiving elements configured to receive data useful for the control of the activable element.

### BRIEF DESCRIPTION OF THE DRAWINGS

Embodiments of the disclosure will now be described, by way of example only, and with reference to the following drawings in which:

FIG. 1 illustrates a side view of a lens element according to an embodiment of the disclosure,

FIG. 2 is a schematic representation of an activable optical element according to the description,

FIGS. 3 to 10 are schematic representation of activable optical elements according to different embodiments of the disclosure, and

FIG. 11 is a schematic representation of an eyewear device according to the disclosure.

Elements in the figures are illustrated for simplicity and clarity and have not necessarily been drawn to scale. For example, the dimensions of some of the elements in the figure may be exaggerated relative to other elements to help to improve the understanding of the embodiments of the present disclosure.

### DETAILED DESCRIPTION OF EMBODIMENTS OF THE DISCLOSURE

In the description, terms like «up», «bottom», «horizontal», «vertical», «above», «below», «front», «rear» or other words indicating relative position may be used. These terms are to be understood in the wearing conditions of the lens element.

In the context of the present disclosure, the term “lens element” can refer to a semi-finished blank, or an uncut optical lens or a spectacle optical lens edged to fit a specific spectacle frame or an ophthalmic lens. The lens element of the present disclosure may also be any of the contact lenses, including daily wear soft contact lens, rigid gas permeable contact lenses, bifocal contact lenses. In addition, the concept of the present invention may be also utilized in intraocular lenses, corneal inlays and onlays.

The lens element of the disclosure may be configured to be mounted in any type of head mounted devices, such as virtual reality head mounted devices or augmented reality head mounted devices.

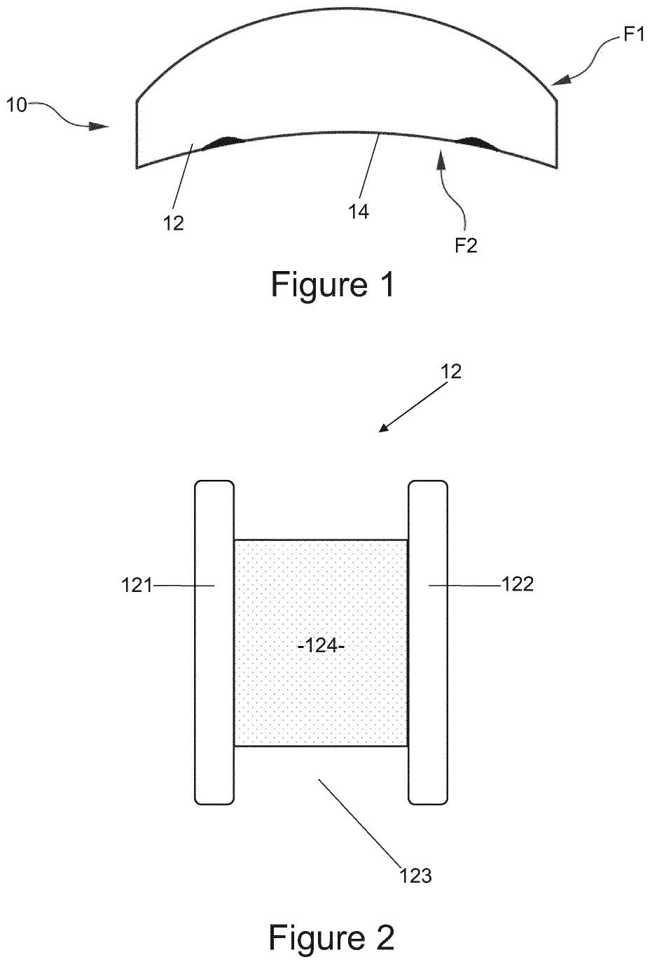

The disclosure relates to a lens element intended to be worn in front of an eye of a wearer. The term “in front of” can refer to either as a certain distance from the eye or on the eye. As represented on FIG. 1, a lens element 10 according to the disclosure comprises two opposite optical faces F1 and F2.

The lens element according to the disclosure has a first optical function and comprises at least one, for example a plurality of, activable optical element 12.

According to a preferred embodiment the first optical function is based on the prescription of the wearer for correcting an abnormal refraction of the eye of the wearer.

The term “prescription” is to be understood to mean a set of optical characteristics of optical power, of astigmatism, of prismatic deviation, determined by an ophthalmologist or optometrist in order to correct the vision defects of the eye, for example, by means of a lens positioned in front of his eye. For example, the prescription for a myopic eye comprises the values of optical power and of astigmatism with an axis for the distance vision.

In the sense of the disclosure, the optical function corresponds to a function providing for each gaze direction the effect of the lens element on the light ray passing through the lens element in specific wearing conditions, for example in standard wearing conditions.

The optical function may comprise a dioptric function, light absorption, polarizing capability, reinforcement of contrast capacity, etc.

The dioptric function corresponds to the lens element power (mean power, astigmatism etc . . . ) as a function of the gaze direction.

The specific wearing conditions preferably relates to standard wearing conditions, however the specific wearing conditions may be personalized wearing conditions that are measured on the wearer when the wearer wears a spectacle frame he/she chose.

The wearing conditions are to be understood as the position of the lens element with relation to the eye of a wearer, for example defined by a pantoscopic angle, a Cornea to lens distance, a Pupil-cornea distance, a center of rotation of the eye (CRE) to pupil distance, a CRE to lens distance and a wrap angle.

The Cornea to lens distance is the distance along the visual axis of the eye in the primary position (usually taken to be the horizontal) between the cornea and the back surface of the lens; for example equal to 12 mm.

The Pupil-cornea distance is the distance along the visual axis of the eye between its pupil and cornea; usually equal to 2 mm.

The CRE to pupil distance is the distance along the visual axis of the eye between its center of rotation (CRE) and cornea; for example equal to 11.5 mm.

The CRE to lens distance is the distance along the visual axis of the eye in the primary position (usually taken to be the horizontal) between the CRE of the eye and the back surface of the lens, for example equal to 25.5 mm.

The pantoscopic angle is the angle in the vertical plane, at the intersection between the back surface of the lens and the visual axis of the eye in the primary position (usually taken to be the horizontal), between the normal to the back surface of the lens and the visual axis of the eye in the primary position; for example equal to 8°.

The wrap angle is the angle in the horizontal plane, at the intersection between the back surface of the lens and the visual axis of the eye in the primary position (usually taken to be the horizontal), between the normal to the back surface of the lens and the visual axis of the eye in the primary position for example equal to 0°.

An example of standard wearer condition may be defined by a pantoscopic angle of 8°, a Cornea to lens distance of 12 mm, a Pupil-cornea distance of 2 mm, a CRE to pupil distance of 11.5 mm, a CRE to lens distance of 25.5 mm and a wrap angle of 0°.

The activable optical element 12 is configured to be switch between a first state in which the activable optical element 12 contributes with the rest of the lens to focus the image of an object at distance on the retina of the wearer, and a second state in which the activable optical element 12 has a second optical function of scattering light so as to slow down the progression of the abnormal refraction of the eye. The light maybe either with a specific wavelength or with a wide spectrum, for example between 380 nm and 780 nm.

As illustrated on FIG. 1, the lens element according to the invention may comprise a refraction area 14 formed as the area other than the areas comprising the at least one activable optical element 12 and having a refractive power based on the prescription for said eye of the wearer.

A lens element 10 according to the disclosure as represented on FIG. 1, comprises an object side surface F1 formed as a convex curved surface on FIG. 1 toward an object side, and an eye side surface F2 formed as a concave surface on FIG. 1 having a different curvature than the curvature of the object side surface F 1.

According to an embodiment of the disclosure, at least part, for example all, of the optical elements are located on the front surface of the lens element.

At least part, for example all, of the optical elements may be located on the back surface of the lens element.

According to a preferred embodiment, at least part, for example all of the optical elements are located between the front and the back surfaces of the optical lens.

The positioning of at least part of the optical elements on the front surface, the back surface or between the front and the back surfaces of the lens element allows customizing the overall optical function to adapt the diffusion according to each wearer needs.

According to an embodiment of the invention the lens element comprises in to addition to the plurality of optical elements a refraction area having a refractive power based on a prescription for the wearer.

Preferably, the refraction area comprises a reference point of the lens element such as the far vision reference point, the optical center of the optical lens and even more preferably the fitting cross of the lens element.

In the sense of the present disclosure, the fitting cross corresponds to the point of reference of the lens element that when mounted in standard wearing condition is centered directly in front of the pupil center of the eye of the wearer in its primary gaze.

The use of the fitting cross enables to correctly mount the lens element in the spectacle frame, so as to slow down the myopia progression effectively.

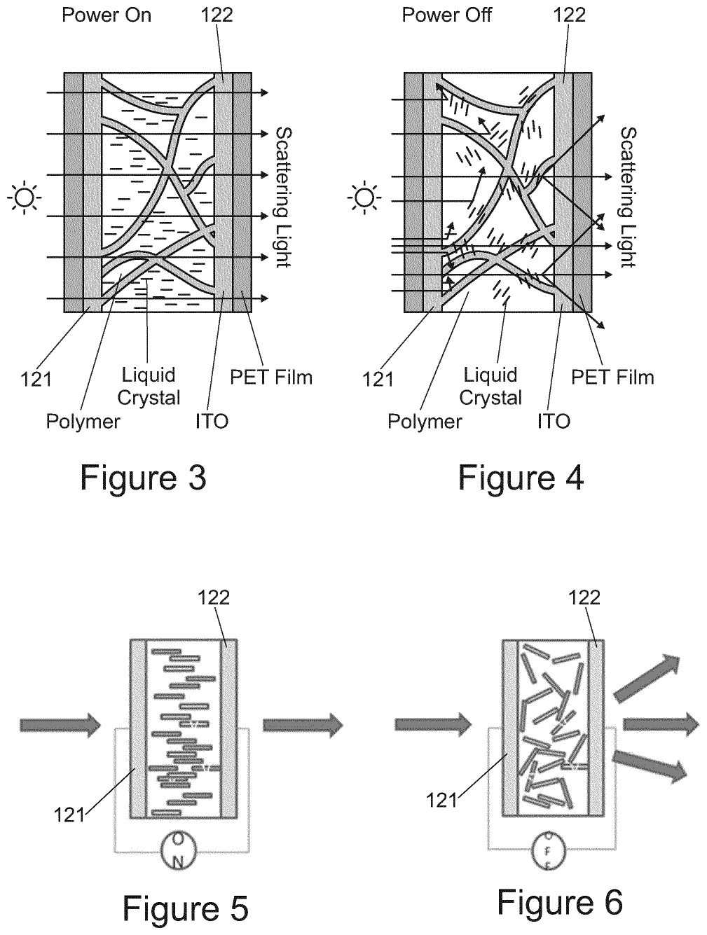

According to an embodiment of the disclosure, illustrated on FIG. 2, the activable optical element comprises a first substrate 121 and a second substrate 122. The second substrate 122 is arranged to face the first substrate 121 and form a cavity 123 between the first and second substrates.

Although on the figures the substrates 121 and 122 are represented as flat substrates, one or both of these substrates may be curved.

The activable optical element comprises an active material 124 disposed between the first and second substrates. The active material is activable between at least a first state and a second state.

In the first state the light scattering function is deactivated, in other words the active activable optical element contributes with the rest of the lens element to focus the image of an object at distance on the retina of the wearer.

In the second state the light scattering function is activated, in other words the optical element scatters light passing through it thus slowing down the progression of the abnormal refraction of the eye.

According to some embodiments of the disclosure, the active material is an electro-active material, in other words, the switch between the first and second state is controlled by applying an electric field.

According to such embodiments, the activable optical element comprises
a first conductive layer disposed on the surface of the first substrate facing the electro-active material, and
a second conductive layer disposed on the surface of the second substrate facing the electro-active material.

The first and second conductive layers are preferably transparent electrodes, for example in conductive transparent oxides, like ITO, FTO, AZO, IGZO, or conductive polymers, like PEDOT:PSS, or also metallic nanowires, like silver nanowires or combination thereof.

The first and second conductive layer may be structured electrodes allowing to activate the electro-active material in specific areas of the lens element.

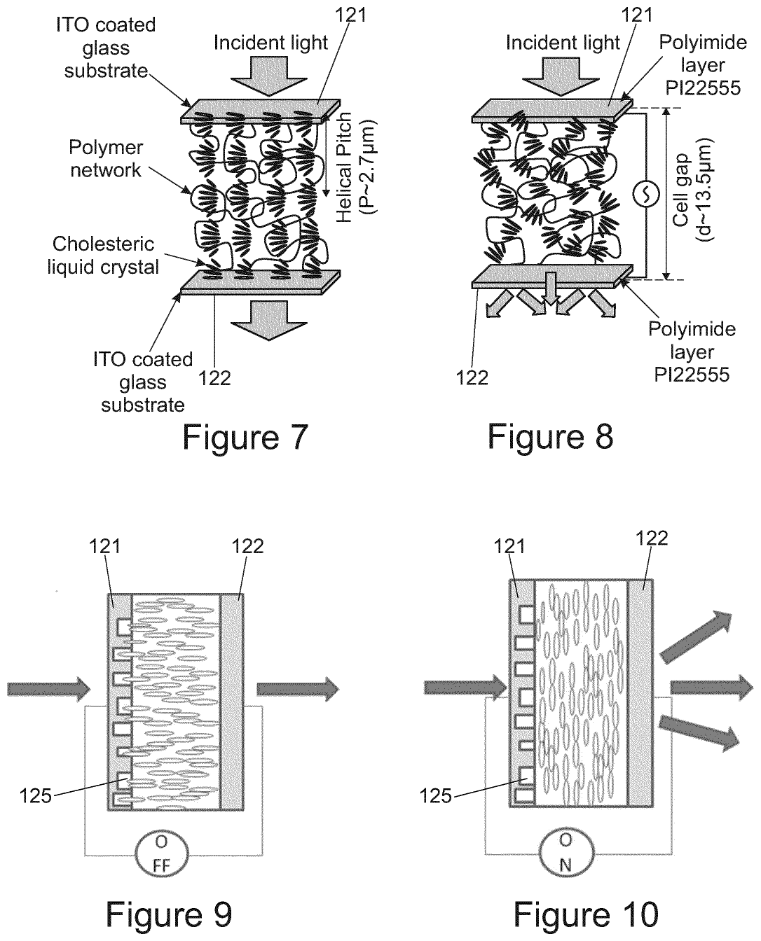

Examples of such embodiments are illustrated on FIGS. 3 to 6.

The scattering may be generated by the organization/orientation of liquid crystals or particles themselves. Applying an electric field may change this organization/orientation which reduces or removes the scattering effect.

A first example is illustrated on FIGS. 3 and 4, with a polymer dispersed liquid crystals (PDLC) placed between two ITO electrodes 121 and 122.

As illustrated on FIG. 3, when an electric field is applied between both electrodes 121 and 122 the liquid crystals align so as to reduce the light scattering. This corresponds to the first state of the activable optical element.

As illustrated on FIG. 4, when no electric field is applied between both electrodes 121 and 122 the liquid crystals orientation is non-aligned creating light scattering. This corresponds to the second state of the activable optical element.

A further example is illustrated on FIGS. 5 and 6, with particles suspended in a matrix (SPD) between two ITO electrodes 121 and 122.

As illustrated on FIG. 5, when an electric field is applied between both electrodes 121 and 122 the particles align so as to reduce the light scattering. This corresponds to the first state of the activable optical element.

As illustrated on FIG. 6, when no electric field is applied between both electrodes 121 and 122 the particles orientation is random creating light scattering. This corresponds to the second state of the activable optical element.

A further example is illustrated on FIGS. 7 and 8, with liquid crystal in a cholesteric phase between two ITO electrodes 121 and 122.

As illustrated on FIG. 7, when no electric field is applied between both electrodes 121 and 122 the liquid crystal align so as to reduce the light scattering. This corresponds to the first state of the activable optical element.

As illustrated on FIG. 8, when an electric field is applied between both electrodes 121 and 122 the orientation of the liquid crystal is a focal conic state creating light scattering. This corresponds to the second state of the activable optical element.

According to an embodiment of the disclosure, the first substrate 121 has a first index of refraction and a light scattering structure. The second substrate 122 has the same first index of refraction as the first substrate 121 and can also have a scattering structure.

The first and the second substrate having the same refractive index enables a maximum transmission rate.

The scattering function is created by scattering centers such as specific roughness 125 on lens surfaces, like microstructures/microlenses made for instance by laser engraving on the surface of the first and/or second substrates 121, 122 or dots/nano particles deposition on the surface of the first and/or second substrates 121, 122.

The active material 124 within the cavity is selected so that in a first state it index of refraction matches the index of refraction of the material in which the scattering centers are realized.

For example, the active material is liquid crystals whose index of refraction changes with its orientation. When applying an electric field, the liquid crystal change their orientation changing their index of refraction.

As illustrated on FIG. 9, when no electric field is applied between both electrodes 121 and 122 the active material has the same index of refraction as the material in which the scattering centers are realized, the scattering centers have no effect on the light. This corresponds to the first state of the activable optical element.

As illustrated on FIG. 10, when an electric field is applied between both electrodes 121 and 122 the active material has a different same index of refraction than the material in which the scattering centers are realized, the scattering centers scatter light. This corresponds to the second state of the activable optical element.

According to an embodiment, the active material is a thermo-optical material whose index of refraction varies with temperature.

The optical element may comprise at least one electrode arranged so as to modify the temperature of the thermo-optical material. For example, the transmission of the substrate with the electrode, for example of the lens element, is higher than 25%, preferably higher than 70% and even preferably higher than 80%.

An example of thermo-optical material is poly(N-isopropyl acrylamide). This material has a transition temperature between 30 and 35° C. Below this temperature it is a clear material, above this temperature it is a hazy material. Other materials behave the same way but at different temperatures or the reverse way (hazy at lower temperature and clear at a higher temperature).

According to an embodiment, the active material is a photo-active material, like azobenzenes.

These molecules can change of conformation (from cis to trans) when they receive some light at a given wavelength. When grafted on a surface which is then covered with a liquid crystal matrix, these azobenzenes can change the orientation of the liquid crystals from a homeotropic orientation to a planar orientation for instance. This change of organization induces a change of refractive index of the material in contact with scattering centers and make them visible or not (more or less hazy).

Another possibility is to introduce these azobenzenes directly inside a liquid crystal matrix. In this case, the azobenzenes induce a phase change of the liquid crystal from a nematic to an isotropic phase. This change of phase also induces a refractive index change of the molecule in contact with the scattering centers.

When using azobenzene, the variation of refractive index can be controlled using a light source included in an eyewear temple that can be activated when scattering is required. In this case, no specific electronic is required on the lens element. A light guide in the lens can also be added to spread the light on the whole lens surface or on specific area on the lens.

One can for instance activate an azobenzene layer on the back surface of the lens using UV light source on the temple. Advantageously, this avoids uncontrolled activation because of ambient light, if using UV cut lens, and activate via UV source.

Another way to use azobenzene without requiring microstructure is to:
use of azobenzene layer on a smooth substrate,
creation of a pattern of index of refraction variation using patterned light. For example, use of a laser diode and groundglass on eyewear temple providing speckle pattern on the azobenzene layer. It creates high spatial frequency pattern of index of refraction variation that provides scattering.

Advantageously, only patterned light from source can create diffusion, so ambient light may just slightly change index of refraction homogenously with very little impact on lens power and no impact on scattering. It is so possible to control scattering with light independently of ambient light (that is generally not patterned, or pattern with low spatial frequency).

The pattern of scattering is preferably designed so that scattering is strong on the lens periphery (for example >5% based on astm D1003, >30 mm diameter area), while being low (for example <0.5%) on lens central area, for example 20 mm diameter area, with optical center being center of this area. It can be progressively varied between peripheral part and central part.

The intensity of diffusion can be varied according to the user profile or activity.

Higher scattering for myopiagenic activity such as reading, near vision activity, low light activity, while lower/no scattering for low myopiagenic activity such as outdoor activity or for safety reasons.

A sensor may be used on the eyewear to detect activity using light level, head posture measurement for instance.

According to an embodiment of the disclosure, the activable material comprise a holographic switchable material.

For example, the lens element according to the disclosure may comprise a substrate having a first index of refraction, at least one holographic mirror disposed on the face of the substrate facing the wearer when the lens element is worn by the wearer, and an activable light source.

When the light source is off the activable optical element is in the first state and contributes with the rest of the lens to focus the image of an object at distance on the retina of the wearer

When the light source is on it generates light that reflected on the holographic mirror generating an image of a scattered element that is reflected toward the eye of the user thereby activating the second optical function of the at least one activable optical element. This corresponds to the second state of the activable optical element.

The lens element according to the invention may comprise receiving means configured to receive data so as to adjust the transitions between the first and second states of the optical elements. For example, the transitions between the first and second states of the optical elements are driven in real-time based on the received data.

The disclosure also relates to an optical device adapted to be positioned on a lens element having a first optical function, for example based on a prescription of the wearer for correcting an abnormal refraction of said eye of the wearer.

The optical device may be positioned on the front or back surface of the ophthalmic lens. The optical device may be an optical patch. The optical device may be adapted to be removably positioned on the ophthalmic lens for example a clip configured to be clipped on a spectacle frame comprising the ophthalmic lens.

The optical device further comprises at least one activable optical element configured so that in a first state the at least one activable optical element contributes with the lens element to focus the image of an object at distance on the retina of the wearer, and in a second state the at least one activable optical element has a second optical function of scattering light so as to slow down the progression of the abnormal refraction of the eye.

The optical element may comprise any of the features relating to the activable optical element described in detail for the lens element.

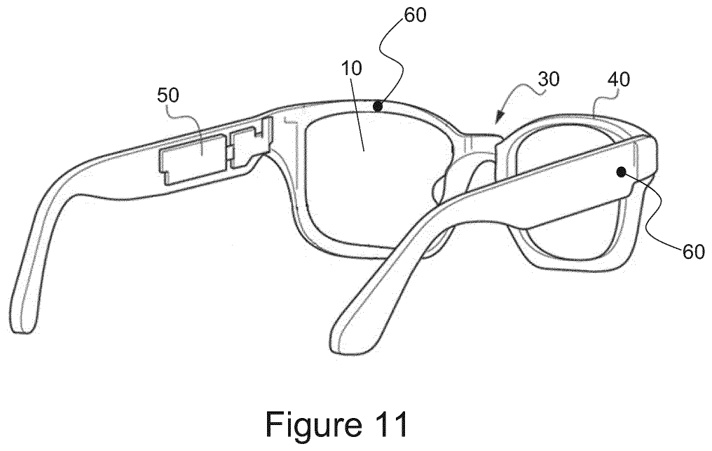

As illustrated on FIG. 11, the invention further relates to an eyewear device 30 comprising a spectacle frame 40 and lens elements 10 mounted in the spectacle frame.

Each lens element 10 has an optical function, for example based on a prescription of the wearer for correcting an abnormal refraction of said eye of the wearer and comprises at least one activable optical element.

As described in detailed previously in a first state the at least one activable optical element contributes with the rest of the lens to focus the image of an object at distance on the retina or the wearer, and in a second state the at least one activable optical element has a second optical function of scattering light so as to slow down the progression of the abnormal refraction of the eye.

The eyewear device may comprise electronic parts 50 to control the activable optical elements of each lens elements. The eyewear device may further comprise light sensors located on the frame, for example on the front or on the back of the frame or on the temples. These light sensors may provide data to control the activable optical element.

The electronic parts 50 may eventually comprises a light source to control the activable optical element. The electronic parts may comprise receiving elements configured to receive data useful for the control of the activable optical element.

The electronic parts 50 may also contain at least one battery to power the light source and the electronic to control the activable element.

The disclosure has been described above with the aid of embodiments without limitation of the general inventive concept.

Many further modifications and variations will suggest themselves to those skilled in the art upon making reference to the foregoing illustrative embodiments, which are given by way of example only and which are not intended to limit the scope of the disclosure, that being determined solely by the appended claims.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the disclosure.

1. A lens element intended to be worn in front of an eye of a wearer having a first optical function, and comprising:
at least one activable optical element,
wherein in a first state the at least one activable optical element contributes with the rest of the lens to focus an image of an object at distance on a retina of the wearer, and in a second state the at least one activable optical element has a second optical function of scattering light so as to slow down the progression of the abnormal refraction of the eye.

2. The lens element according to claim 1, further comprising a refraction area formed as the area other than the areas comprising the at least one activable optical element and having a refractive power based on a prescription for said eye of the wearer.

3. The lens element according to claim 2, wherein the refraction area comprises a fitting cross of the lens element.

4. The lens element according to claim 1, wherein the at least one activable optical element is located on a front surface, a back surface, or between the front and the back surfaces of the lens element.

5. The lens element according to claim 1, wherein the at least one activable optical element further comprises:
a first substrate and a second substrate being arranged to face the first substrate and form a cavity between said first and second substrates, and
an active material disposed between the first and second substrates, the active material being activable between at least a first state and a second state, and
wherein the first state corresponds to a deactivated light scattering function and the second state corresponds to an active light scattering function.

6. The lens element according to claim 5, wherein the active material is an electro-active material and wherein the at least one activable optical element further comprises:
a first conductive layer disposed on a surface of the first substrate facing the electro-active material, and
a second conductive layer disposed on a surface of the second substrate facing the electro-active material.

7. The lens element according to claim 6, wherein the first and second conductive layer are structured electrodes allowing activation of the electro-active material in specific areas of the lens element.

8. The lens element according to claim 5, wherein the active material is a thermo-optical material whose index of refraction varies with temperature.

9. The lens element according to claim 5, wherein the active material is a photo-active material.

10. The lens element according to claim 5, wherein the active material is activable between at least a transparent state and a scattering induced state.

11. The lens element according to claim 5, wherein
the first substrate has a first index of refraction and a light scattering structure providing the second optical function, and
the second substrate has said first index of refraction, and
wherein in a first state, the first and second substrates and the active material have the same index of refraction and participate to the first optical function, and in a second state, the index of refraction of the active material is modified, thereby activating the second optical function.

12. The lens element according to claim 1, further comprising:
a substrate having a first index of refraction,
at least one holographic mirror disposed on a face of the substrate facing the wearer when the lens element is worn by the wearer, and
at least one activable light source,
wherein in a first state, the light source is off, and in a second state, the at least one activable light source generates light that reflected on the holographic mirror generates an image of a scattered element that is reflected toward the eye of a user thereby activating the second optical function of the at least one activable optical element.

13. The lens element according to claim 1, further comprising receiving means configured to receive data,
wherein transitions between the first and second states of the optical elements are driven in real-time based on the received data.

14. (canceled).

15. An optical device adapted to be positioned on a lens element having a first optical function, the optical device comprising:
at least one activable optical element configured so that in a first state the at least one activable optical element contributes with the lens element to focus an image of an object at distance on a retina of a wearer, and in a second state the at least one activable optical element has a second optical function of scattering light so as to slow down progression of abnormal refraction of an eye.

16. The optical device according to claim 15, wherein the at least one active optical element comprises a microstructure or at least one micro-lens.

17. An eyewear device comprising:
lens elements, wherein each lens element has an optical function, and
at least one activable optical element, wherein in a first state the at least one activable optical element contributes with the rest of the lens to focus an image of an object at distance on a retina or a wearer, and in a second state the at least one activable optical element has a second optical function of scattering light to slow down progression of abnormal refraction of the eye.
